(19) United States
(12) Patent Application Publication
(10) Pub. No.: US 2007/0036302 A1
(43) Pub. Date: Feb. 15, 2007

(54) Method of proving service for telephone call recording and system thereof

(75) Inventor: Hang-Jei Cho, Seoul (KR)

Correspondence Address: IPLA P.A., 3580 WILSHIRE BLVD., 17TH FLOOR, LOS ANGELES, CA, 90010, US

(73) Assignee: T & C TECHNOLOGY CO., LTD., Seoul (KR)

(21) Appl. No.: 10/568,938

(22) PCT Filed: Aug. 26, 2004
(86) PCT No.: PCT/KR04/02141

§ 371 Date: Feb. 21, 2006

(30) Foreign Application Priority Data
Aug. 26, 2003 (KR) 10-2003-0060037
Sep. 23, 2003 (KR) 10-2003-0065929

(51) Int. Cl. H04M 1/64

(52) U.S. Cl. 379/88.23

(57) ABSTRACT

Conventionally, there is a method where a certification of contents is mailed in order to legally prove that intention of one party is transferred to an opposite party. Namely, one party who desires to retain a legal evidence showing that the one party transferred his intention to the opponent party mails the content certification to prove such a transfer of the intention from the one party to the opponent party. However, this method has a problem in that an emotional trouble may arise between the two parties. The present invention provides a method of proving service for telephone call recording and a system thereof, wherein a calling party inputs a telephone number of a call content proving apparatus and a telephone number of a called party to establish call connection with the call content proving apparatus and the called party, content of a call between the calling party and the called party is automatically recorded in the call content proving apparatus, and a certificate for the recorded call content is issued by the call content proving apparatus, so that the content of the call between the calling party and the called party can be proved by the certificate issued by the call content proving apparatus and can be opened to other parties.

### TECHNICAL FIELD

The present invention relates to a service method of proving telephone call recording and a system thereof. This system is capable of recording a call between two parties (a calling party and a called party) by a request from the calling party, proving the call between the two parties by means of a certificate for the recorded call, which is issued by a third party, and opening the recorded call to another third party.

### BACKGROUND ART

Since the introduction of caller identification display system to telephone service, calling party numbers can be identified for most telephones. Also, by virtue of the development of computers and telephone systems, various types of calling methods in addition to past simple telephone services (services in which a calling party establishes call connection with a called party by inputting the called party's telephone number into the calling party's telephone) have been introduced to provide a variety of telephone call systems. In addition, a service of voice recording of the telephone call is being widely used for client consultation or telephone sales. Furthermore, by virtue of the development of Internet technologies and security technologies on the Internet, an authentication by a third party for various kinds of electronic documents exchanged between any two parties is commonly being used.

Conventionally, there is a method where a certification of contents is mailed in order to legally prove that intention of one party is transferred to an opposite party. Namely, the party desiring to retain legal evidence showing that the one party transferred his intention to the opposite party mails the content certification to prove such a transfer.

However, this method has a problem in that an emotional trouble may arise between the two parties.

### DISCLOSURE

[Technical Problem]

The present invention has been made in view of the above problem, and it is the purpose of the present invention to provide a method of proving service for telephone call recording and a system thereof, wherein a calling party inputs a telephone number of a call content proving apparatus (hereby apparatus) and a telephone number of a called party to establish call connection with the call apparatus and the called party, content of a call between the calling party and the called party is automatically recorded in the apparatus. Then a certificate for the recorded call content is issued by the apparatus, therefore prove the content of the call between the calling party and the called party. This certificate enables the content of the call to be opened to other parties as well.

Another purpose of the present invention to provide a method of proving service for telephone call recording and a system thereof, which is capable of legally proving call content and fact of call made between two parties (a calling party and a called party).

This feature of the system is capable of restrictively sending information via Internet by recording call content between two parties and sending the recorded call content to a called party, using a certificate number for the recorded call content and a reading password by use of which only the called party can hear the recorded call content, so that a calling party can send the recorded call content to only the called party.

[Technical Solution]

In accordance with one aspect of the present invention, the above and other objectives can be accomplished by the provision of a method of proving service for telephone call recording. This process comprises the steps of: a calling party, telephoning a telephone call recording proof apparatus via a communication network and inputting a telephone number of a called party to the apparatus recording the telephone call content between the calling party and the called party, storing the recorded telephone call content as voice recording information, generating a unique authentication number for the stored voice recording information, and sending the generated unique authentication number to the calling party via the communication network; the apparatus generating and storing call confirmation information by means of which the telephone call between the calling party and the called party is confirmed; the apparatus issuing a certificate for the recorded telephone call content when the calling party or a third party who knows the unique authentication number telephones the telephone call recording proof apparatus via the communication network and then inputs the unique authentication number to the telephone call recording proof apparatus; and after performing the authentication process, the telephone call recording proof apparatus, allowing the calling party or the third party to hear the recorded voice recording information via the communication network or sending the call confirmation information through which the telephone call can be confirmed to the calling party or the third party via the communication network.

The step of issuing a certificate includes: the calling party, telephoning the telephone call recording proof apparatus via the communication network; by the calling party, inputting the unique authentication number to the telephone call recording proof apparatus; the telephone call recording proof apparatus, confirming whether the authentication number inputted by the calling party is present in the telephone call recording proof apparatus; if the authentication number inputted by the calling party is present in the apparatus the telephone call recording proof apparatus, confirming whether the authentication number has been paid for; if the authentication number has not yet been paid, by the telephone call recording proof apparatus, requesting the calling party to pay for the authentication number and processing the payment of the calling party; and the telephone call recording proof apparatus, issuing the certificate to the calling party via the communication network.

The step of generating a unique authentication number for the stored voice recording information includes: the apparatus, confirming a telephone number of the calling party, informing the calling party that the telephone call is being recorded, and requesting the calling party to input the telephone number of the called party to the telephone call recording proof apparatus; if the telephone number of the calling party is not confirmed, by the telephone call recording proof apparatus, sending the calling party a message, informing that it is impossible to provide service to the calling party; the calling party, inputting the telephone number of the called party to the telephone call recording proof apparatus; the telephone call recording proof apparatus, telephoning the called party and establishing a call connection between the calling party and the called party; the telephone call recording proof apparatus, recording the telephone call content between the calling party and the called party; the telephone call recording proof apparatus, stopping the recording when the telephone call between the calling party and the called party is terminated; the telephone call recording proof apparatus, storing the recorded telephone call content between the calling party and the called party as voice recording information; and the telephone call recording proof apparatus, generating a unique authentication number for the voice recording information.

The communication network includes wired and wireless communication networks, public switched telephone networks, Internet communication networks, and satellite communication networks.

The certificate includes a certificate number, the telephone number of the calling party, the telephone number of the called party, call date and call time, and details of issue of the certificate.

The authentication number is one of the serial numbers specified in the apparatus, the telephone number of the calling party, and the telephone number of the calling party, or a combination thereof.

In accordance with the second aspect of the present invention, there provided a method of proving service for telephone call recording using the apparatus for recording telephone call content between a calling party and a called party as voice recording information by a request from the calling party and issuing an authentication number and a certificate for the recorded voice recording information to the calling party, the method comprising the steps of: the calling party, telephoning the telephone call recording proof apparatus and inputting a telephone number of the called party to the telephone call recording proof apparatus in order to record the telephone call content between the calling party and the called party; the telephone call recording proof apparatus, generating a unique authentication number for the recorded voice recording information and issuing the generated unique authentication number to the calling party via a communication network; the calling party, telephoning the apparatus via the communication network and inputting the authentication number to the apparatus so that the calling party can hear the voice recording information; the telephone call recording proof apparatus, receiving an e-mail address of the called party from the calling party after performing an authentication process for the authentication number; the telephone call recording proof apparatus, generating a voice mail reading password by use of which the voice recording information can be heard and sending the generated voice mail reading password to the called party; the apparatus, sending a search path of the voice recording information by use of which the voice recording information can be heard to the e-mail address of the called party; the called party, accessing the search path of the voice recording information via Internet network and inputting the voice mail reading password to the search path for performing an authentication process; and after performing the authentication process, the called party, hearing the voice recording information.

The authentication number is one of the serial numbers received from the telephone call recording proof apparatus, the telephone number of the calling party, and the telephone number of the called party, or a combination thereof.

In accordance with the third aspect of the present invention, there is provided a method of proving service for telephone call recording using the apparatus for providing a telephone call diary service for recording and preserving telephone call content between a calling party and a called party, as voice recording information, in the form of a diary in a virtual memory region assigned to the calling party by a request from the calling party and issuing an authentication number and a certificate for the voice recording information recorded in the virtual memory region to the calling party, the method comprising the steps of: the calling party, telephoning the apparatus by inputting a called number of the telephone call recording proof apparatus and a telephone number of the called party sequentially to a telephone or a mobile terminal of the calling party in order to automatically record the telephone call content between the calling party and the called party; the apparatus, generating an authentication number for the recorded voice recording information and issuing the generated authentication number to the calling party via a communication network; the calling party, accessing the telephone call recording proof apparatus via Internet; the apparatus, determining whether the calling party is a subscriber to the telephone call diary service, and if the calling party is a subscriber, causing the calling party to move to the virtual memory region of the calling party. Otherwise, causing the calling party to move to a virtual memory region assigned after the calling party subscribes to the telephone call diary service through a subscription process; by the calling party, inputting the authentication number to the virtual memory region; and by the telephone call recording proof apparatus, providing a hearing path of the voice recording information to the calling party.

The method of proving service for telephone call recording further comprises the steps of: the calling party, inputting the authentication number to the telephone call recording proof apparatus; the telephone call recording proof apparatus, searching for the voice recording information corresponding to the inputted authentication number from the virtual memory region assigned to the calling party and providing the retrieved voice recording information to the calling party via the communication network.

The method of proving service for telephone call recording method further comprises the step of: by the calling party, accessing the telephone call recording proof apparatus and hearing the recorded telephone call content after performing an authentication process using the authentication number.

The authentication number is one of the serial numbers received from the telephone call recording proof apparatus, the telephone number of the calling party, and the telephone number of the called party, or a combination thereof.

In accordance with the forth aspect of the present invention, there provided a system for proving service for telephone call recording, and the system including a telephone call recording proof apparatus, wherein the telephone call recording proof apparatus records a telephone call content between a calling party and a called party by a request from the calling party. The apparatus then generates a unique authentication number for voice recording information including the recorded telephone call content between the calling party and the called party, sends the generated unique authentication number to the calling party via a communication network, generates and stores call confirmation information by means of which the telephone call between the calling party and the called party is confirmed, and, after performing an authentication process for the authentication number inputted by the calling party or a third party via the communication network, sends the voice recording information to the calling party or the third party via the communication network so that the calling party or the third party can hear the voice recording information or sends the call confirmation information by use of which the telephone call can be confirmed to the calling party or the third party.

The telephone call recording proof apparatus includes: a call connection module for connecting with the calling party or the called party via the communication network; a voice recording module for recording voice call after the voice recording module connects with the call connection module and storing the recorded voice call as voice recording information in a magnetic disk; a service website for providing communication between the calling party and the called party via an Internet network; and a database (DB) server including the magnetic disk in which the voice recording information is stored and instruction modules for executing database instructions for the voice recording information.

The call confirmation information includes information on a telephone number of the calling party, a telephone number of the called party, call date and time, fact of call between the calling party and the called party, and the telephone call content.

The telephone call recording proof apparatus records the telephone call content between the calling party and the called party in a form of a diary in a virtual memory region assigned to the calling party, and stores the recorded telephone call content as the voice recording information.

The telephone call recording proof apparatus records the telephone call content between the calling party and the called party in a form of a diary in a virtual memory region assigned to the calling party, and stores the recorded telephone call content as the voice recording information.

The step of sending the generated unique authentication number to the calling party includes: if a call path of the calling party is not released, informing the calling party of the authentication number by voice. If the calling party terminates the call, informing the calling party of the authentication number by voice or a short message by reestablishing a call connection with the calling party.

The call confirmation information includes information on a telephone number of the calling party, a telephone number of the called party, call date and time, fact of call between the calling party and the called party, and the telephone call content.

[Advantageous Effects]

According to the method of proving service for telephone call recording and system thereof, recording the call content between two parties (the calling party and the called party) by a request from the calling party and issuing a certificate for the recorded call content by a third party, the call content between the calling party and the called party can be proved by the certificate issued by the third party and can be opened to other parties.

Additionally, call content and the fact that a call is made between two parties (the calling party and the called party) can be legally proved through notarization by a third party.

Call content and fact of call between two parties. (the calling party and the called party) can be confirmed by recording the call content between the two parties and allowing only the two parties to hear the recorded call content between the two parties, using a certificate number (or recording number) for the recorded call content.

Call content between two parties (the calling party and the called party) can be preserved via an Internet network and can be confirmed if necessary by recording the call content between the two parties and using a certificate number (or recording number) for the call content between the two parties.

An inconvenience of conventional content certification and a limitation on a legal power of evidence of a simple deposition (for example, record faking and impossibility of proof of telephone call time) can be overcome.

When the present invention is widely used, call content between two parties can be easily notarized through a simple service.

Call content between two parties can be preserved by providing an electronic mail service for recording and confirming the call content between the parties in addition to legally proving the call content.

Finally, in the case of a telephone call diary service, call content between two parties (for example, family, lovers, etc) can be preserved for a long time and can be mutually opened, which may create a new recording method such as a photograph album or a diary album.

### DESCRIPTION OF THE DRAWINGS

The above and other objectives, features and other advantages of the present invention will be more clearly understood from the following detailed description taken in conjunction with the accompanying drawings, in which:

FIG. 1 is a diagram illustrating a general configuration of a telephone call recording proof service system according to the present invention;

FIG. 2 is a diagram illustrating a detailed configuration of the telephone call recording proof apparatus in FIG. 1;

FIG. 3 is a flow chart illustrating a process for recording a telephone call in a telephone call recording proof service method according to the present invention;

FIG. 4 is a flow chart illustrating a process for issuing a certificate proving telephone call content in the telephone call recording proof service method according to the present invention;

FIG. 5 is a flow chart illustrating a process for confirming content of the recorded telephone call in the telephone call recording proof service method according to the present invention;

FIG. 6 is a flow chart illustrating a process for hearing voice record information via an Internet network in the telephone call recording proof service method according to the present invention;

FIG. 7 is a flow chart illustrating a process for transmitting a hearing path of the voice record information by means of an e-mail from a calling party to a called party via the Internet network so that the called party can hear the voice record information, in the telephone call recording proof service method according to the present invention; and

FIG. 8 is a flow chart illustrating a process where the calling party stores the content of the telephone call in a virtual memory region assigned to him in the telephone call recording proof service method according to the present invention.

### MODE FOR INVENTION

Hereinafter, preferred embodiments of the present invention will be described in detail with reference to the accompanying drawings.

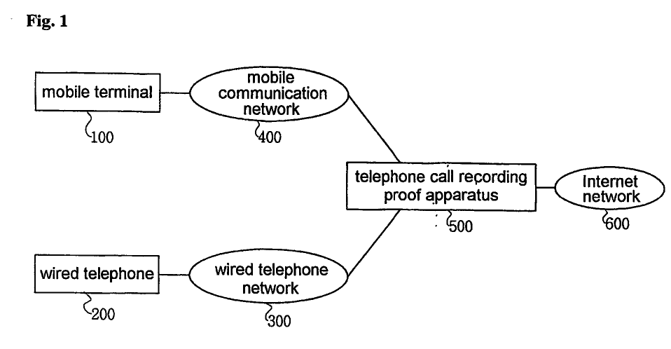

FIG. 1 is a diagram illustrating a general configuration of a telephone call recording proof service system according to the present invention. As shown in FIG. 1, this system includes a mobile terminal 100, a wired telephone 200, a wired telephone network 300, a mobile communication network 400, a telephone call recording proof apparatus 500, and an Internet network 600.

The mobile communication network 400 is generally referred to as mobile communication service providers to carry on business using a mobile terminal 100, including cellular phone service providers, personal communication service (PCS) providers, trunked radio system (TRS) providers, etc.

The mobile terminal 100 used to access the mobile communication network 400 is a terminal having its own unique number to make access to the mobile communication network 400 possible for providing services provided by the mobile communication network 400.

The wired telephone network 300 is generally referred to as a local telephone network service provider, a toll telephone network service provider, and an international telephone network service provider. The wired telephone 200 is a terminal having its own unique number assigned to a subscriber of the local telephone network.

The telephone call recording proof apparatus 500 is coupled to the mobile terminal 100 and the wired telephone 200 of the calling party via the mobile communication network 400 or the wired telephone network 300, respectively, and is coupled to a computer terminal (not shown) or the mobile terminal 100 of the calling party via the Internet network 600.

The telephone call recording proof apparatus 500 records the telephone call content between the calling party and the called party by a request from the calling party and issues an authentication number (or recording number) for the recorded telephone call content to the calling party. In addition, the telephone call recording proof apparatus 500 issues a certificate for proving the telephone call content with the called party to the calling party after authentication using the authentication number. The calling party or a third party hears the telephone call content through one of the mobile communication network 100, the wired telephone network 300 and the Internet network 600 after authentication process using the authentication number.

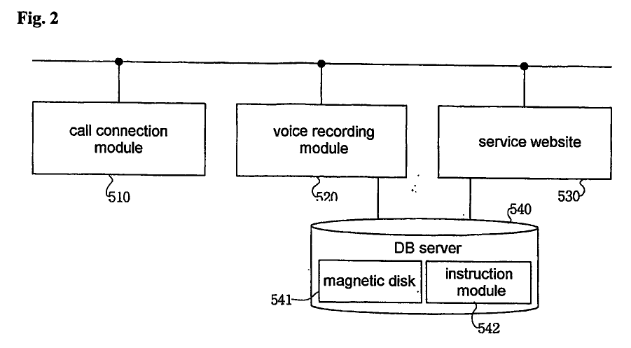

FIG. 2 is a diagram illustrating a detailed configuration of a telephone call recording proof apparatus 500 in FIG. 1, including a call connection module 510, a voice recording module 520, a service website 530, and a database (DB) server 540.

The call connection module 510, which is a part for call connection through a telephone network, performs various operations for voice call connection with the calling party, the called party and the telephone call recording proof apparatus 500 in cooperation with the telephone network in various ways (i.e., for example, through signal network or VoIP network interworking).

The voice recording module 520 records a voice call after establishing a call path with the call connection module 510, and then stores the recorded voice call in a magnetic disk.

The service website 530, which refers to an Internet website connected to the Internet network 600, provides a user matching function over the Internet for issue of the certificate.

The DB server 540 includes the magnetic disk 541 for storing the telephone call content and an instruction module 542 for performing database instructions for information on the stored voice call.

The telephone call recording proof service system according to the present invention as shown in FIGS. 1 and 2 is illustrated as one example of a logical configuration. This system may be implemented with various subsystems according to employed hardware, or alternatively, may be integrated into a single hardware system.

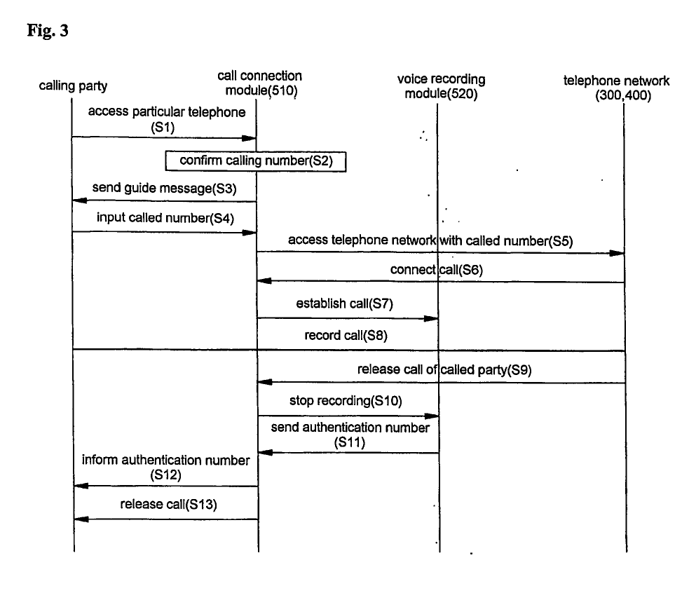

FIG. 3 is a flow chart illustrating a process for recording a telephone call in a telephone call recording, proof service method according to the present invention.

Referring to FIG. 3 in conjunction with FIGS. 1 and 2 to begin with, the calling party telephones the telephone call recording proof apparatus 500 with a particular telephone number using the mobile terminal 100 or the wired telephone 200 in order to store telephone call content with the called party (Step S1). Then, the call connection module 510 of the telephone call recording proof apparatus 500 accesses the mobile terminal 100 or the wired telephone 200 via the mobile communication network 400 or the wired telephone network 300 and confirms a telephone number (calling number) of the calling party (Step S2). In this case, the calling party must possess a calling party telephone number provided by a calling number service.

If the telephone number of the calling party cannot be confirmed, the call connection module 510 informs the mobile terminal 100 or the wired telephone 200 of the calling party through text or voice that it is impossible to provide service to the mobile terminal 100 or the wired telephone 200. Otherwise, the call connection module 510 sends a guide message informing that the telephone call content is being recorded to the mobile terminal 100 or the wired telephone 200 through text or voice (Step S3) and then requests the calling party to input a telephone number (called number) of the called party.

Next, the calling party requested to input the called number inputs the called number through the mobile terminal 100 and the wired telephone 200 (Step S4).

Next, the call connection module 510 of the telephone call recording proof apparatus 500 accesses the wired telephone network 300 or the mobile communication network 400 and attempts to establish a call connection with the called number inputted by the calling party (Step S5).

Next, if the call connection module 510 is informed by the wired telephone 300 or the mobile communication network 400 that the call connection with the called number is successfully established, it makes a request for call access to the voice recording module 520 (Step S6).

Next, when the call connection module 510 makes the call access request to the voice recording module 520, it establishes a call connection with the voice recording module 520 such that the telephone call content is recorded (Step S7). Then, the voice recording module 520 records the telephone call content between the calling party and the called party through the wired telephone network 300 or the mobile communication network 400 (Step S8).

Next, when the call connection with the called number is released by one of the mobile terminal 100 and the wired telephone 200 of the called party or the calling party (Step S9), the call connection module 510 detects this release and requests the voice recording module 520 to release the call connection and stop the recording of the telephone call content (Step S 10).

Next, the voice recording module 520 stores a result of the recording (recording data information) in the magnetic disk 541 of the DB server and transmits a serial number (authentication number), which does not overlap with numbers for previously written recording data information, to the call connection module 510 (Step S11).

Next, the call connection module 510 informs the mobile terminal 100 or the wired telephone 200 of the calling party of the authentication number (Step S12). At this time, if a call path of the calling party is not released, the calling party is informed of the authentication number by voice, and if the calling party terminates the call, the calling party is informed of the authentication number by voice by reestablishing a call connection with the calling party. In this case, if the calling party uses the mobile terminal 100, the call connection module 510 informs the mobile terminal 100 of the authentication number using a short message service which is one of general mobile communication services.

Next, the call connection module 510 terminates the call connection service by releasing the call connected to the calling party (Step S13).

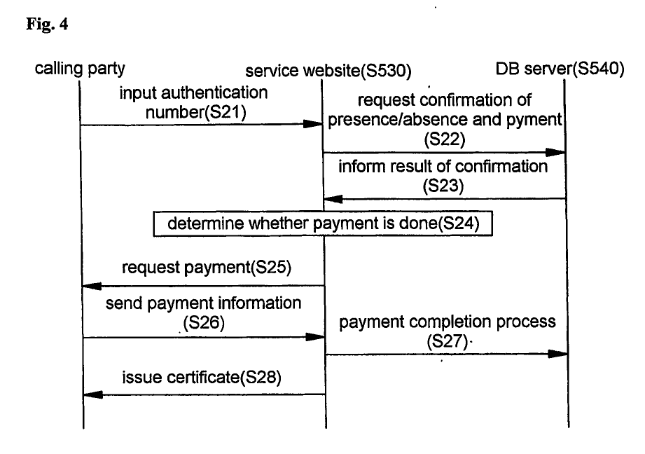

FIG. 4 is a flow chart illustrating a process for issuing a certificate proving the telephone call content in the telephone call recording proof service method according to the present invention.

Referring to FIG. 4 in conjunction with FIGS. 1 to 3, to begin with, the calling party to whom the authentication number is issued, as shown in FIG. 3, accesses the service website 530 of the telephone call recording proof apparatus 500 via the Internet network 600 and inputs the issued authentication number to the service website 530 (Step S21).

Next, the service website 530, having received the authentication number, requests the DB server 540 to check whether the received authentication number is present in the DB server 540 and, if present, whether it has been paid for (Step S22).

Next, the DB server 540 informs the service website 530 of a result of the check on whether the authentication number inputted by the calling party is present and, if present, whether it has been paid for (Step S23). If the authentication number inputted by the calling party is not present in the DB server 540, the DB server 540 informs the service website 530 that the authentication number is not present. Also, if the authentication number has not been paid for although it is present, the service website 530 is informed of that fact.

Next, based on the result of the check on whether the authentication number is present and has been paid for, the service website 530 determines whether the authentication number has been paid for (Step S24), and, if the authentication number has not been paid for, requests the calling party who accessed the service website 530 to pay for a certificate to be issued to the calling party (Step S25).

Next, when the calling party inputs payment information to the service website 530 (Step S26), the service website 530 stores the payment information for the authentication number of the calling party in the DB server 540 and then terminates the payment procedure as described above (Step S27). In this case, when the calling party is requested to pay for the authentication number, he completes the payment through various payment methods including an Internet payment service, various offline payment services, etc.

Next, the service website 530 issues an electronic certificate through the Internet network 600 by a request from the calling party (Step S28). In this case, the certificate necessarily includes an authentication number, a calling party number, a called party number, call time, etc.

The calling party to whom the certificate is issued can preserve and use the certificate as evidence for various legal actions.

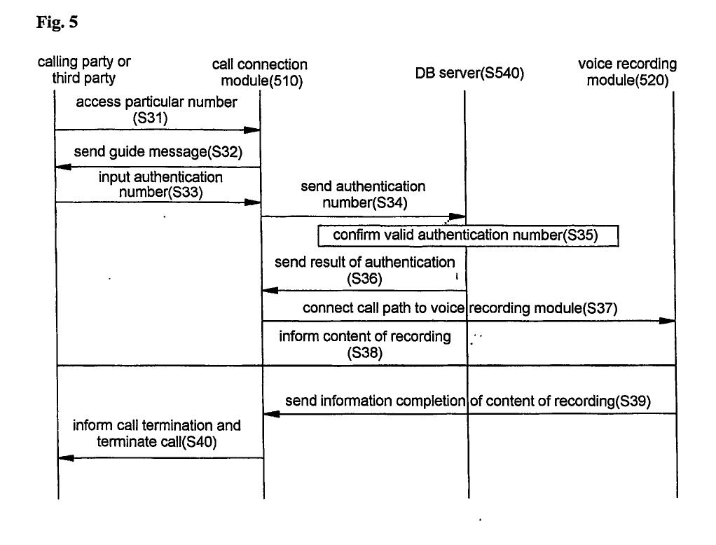

FIG. 5 is a flow chart illustrating a process for confirming the content of the recorded telephone call in the telephone call recording proof service method according to the present invention.

Referring to FIG. 5 in conjunction with FIGS. 1 to 4, to begin with, after the telephone call content between the calling party and the called party is recorded in the telephone call recording proof apparatus 500, if the calling party or the third party who knows an authentication number for the recorded telephone call content wants to confirm the telephone call content recorded in the telephone call recording proof apparatus 500, or if the calling party or the third party who knows a certificate number of a certificate issued by the telephone call recording proof apparatus 500 wants to hear the telephone call content recorded in the telephone call recording proof apparatus 500, he telephones and accesses the telephone call recording proof apparatus 500 using a particular telephone number (Step S31).

Next, the call connection module 510 of the telephone call recording proof apparatus 500 requests, through a guide message (voice and/or text), a person (calling party or third party) who attempts to access the telephone call recording proof apparatus 500 to input his authentication number (or certificate number) (Step S32).

Next, when the calling party or the third party inputs the authentication number to the telephone call recording proof apparatus 500 using the mobile terminal 100 or the wired telephone 200 (Step S33), the call connection module 510 inquires of the DB server 540 about the authentication number (Step S34).

Next, the DB server 540 confirms whether the authentication number received from the call connection module 510 is a valid authentication number of the telephone call content which can be heard by the calling party or the third party (Step S35) and then, a result of the confirmation is reported to the call connection module 510 (Step S36).

Next, if the result of the confirmation received from the DB server 540 is an authentication number of the telephone call content which can be heard by the calling party or the third party, the call connection module 510 establishes a call path with the voice recording module 520 (Step S37), and then, informs the calling party or the third party of the recorded telephone call content and information on a calling party number, a called party number, call time included in the certificate (Step S38).

Next, the voice recording module 520 informs the call connection module 510 that the recorded telephone call content has been completely informed (Step 39).

Next, the call connection module 510 sends the calling party or the third party a guide message arty and inputs the authentication number to the service website 530 which then issues the certificate (the certificate issuing step).

In addition, as shown in FIG. 5, if the calling party or the third party who knows the authentication number or the certificate number wants to confirm the telephone call content between the calling party and the called party, he telephones the call connection module 510 of the telephone call recording proof apparatus 500 and inputs the authentication number or the certificate number to hear the recorded telephone call content between the calling party and the called party (the call content confirming step).

As described above, the telephone call recording proof service method of the present invention includes three sequential steps, i.e., the recording and authentication number issuing step (FIG. 3), the certificate issuing step (FIG. 4) and the call content confirming step (FIG. 5).

Another embodiment is that the telephone call recording proof service method of the present invention includes two sequential steps, i.e., the recording and authentication number issuing step (FIG. 3) and the certificate issuing step (FIG. 4).

Also the telephone call recording proof service method of the present invention includes two sequential steps, i.e., the recording and authentication number issuing step (FIG. 3) and the call content confirming step (FIG. 5).

Finally, the telephone call recording proof service method of the present invention includes three sequential steps, i.e., the recording and authentication number issuing step (FIG. 3), the call content confirming step (FIG. 5) and the certificate issuing step (FIG. 4).

Alternatively, in the telephone call recording proof service method of the present invention, after performing the authentication process using the telephone numbers of the calling party and the called party instead of the authentication number used for authentication of the calling party or the third party, the telephone call recording proof apparatus 500 can issue the certificate or allow the calling party or the third party who accesses the telephone call recording proof apparatus 500 to hear the telephone call content recorded in the telephone call recording proof apparatus 500.

Additionally, the telephone call recording proof apparatus 500 notarizes information related to the telephone call content, history of telephone call, details of issue of the certificate, etc., through an electronic notarizing process.

Moreover, the telephone call recording proof apparatus 500 prints out the certificate issued to the calling party in the form of an electronic document or a document to be notarized legally.

In order to enhance a power of notarization for others, the present invention may include an electronic notarization service provided by particular authorities. Through such an electronic notarization service, a variety of procedures for the authentication process can be added. In this case, the authorities for proof of the telephone call content may be mobile communication network service providers or wired telephone network service providers, or alternatively information authentication enterprises having a legal power of authentication for preservation and distribution of electronic documents. Accordingly, authorities for providing the telephone call recording proof service may be present in various forms.

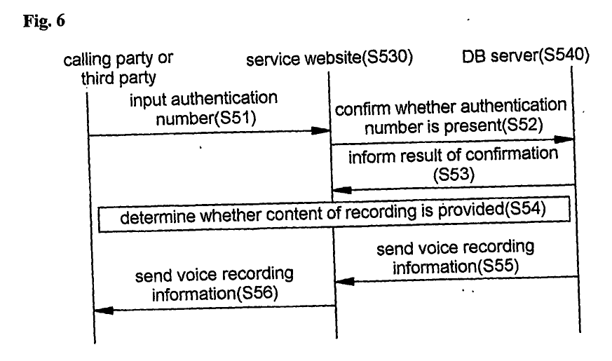

FIG. 6 is a flow chart illustrating a process for hearing voice record information via an Internet network in the telephone call recording proof service method according to the present invention.

Referring to FIG. 6, in order to record the telephone call content with the called party in the telephone call recording proof apparatus 500 and then allow the calling party and the third party to hear the recorded telephone call content (voice recording information), the following steps are performed.

To begin with, the calling party accesses the service website 530 of the telephone call recording proof apparatus 500 via the Internet network and then inputs the authentication number (or the certificate number) to the service website 530 (Step S51). At this time, the telephone call recording proof apparatus 500 recognizes the authentication number inputted by the calling party as a recording number.

Next, the service website 530 requests the DB server 540 to confirm whether the inputted authentication number is present in the DB server 540 (Step S52).

Next, the DB server 540 informs the service website 530 of a result of the confirmation on whether the authentication number inputted by the calling party or the third party is present in the DB server 540 (Step S53).

Next, the service website 530 determines whether the recorded telephone call content (voice recording information) should be provided to the calling party or the third party according to the result of the confirmation received from the DB server 540 (Step S54). In this case, if the authentication number inputted by the calling party or the third party is not present in the DB server 540, the calling party or the third party is informed of absence of the authentication number. If the authentication number is present, a search path of the voice, recording information is received from the DB server 540 (Step S55) and then is sent to the calling party or the third party (Step S56) via the Internet network 600.

A system for sending the 'search path of voice recording information using an e-mail of the Internet network 600 may raise privacy infringement issues if the called party is not informed of that the telephone call will be recorded. In order to avoid these issues, an additional procedure may be included in a mail sending process.

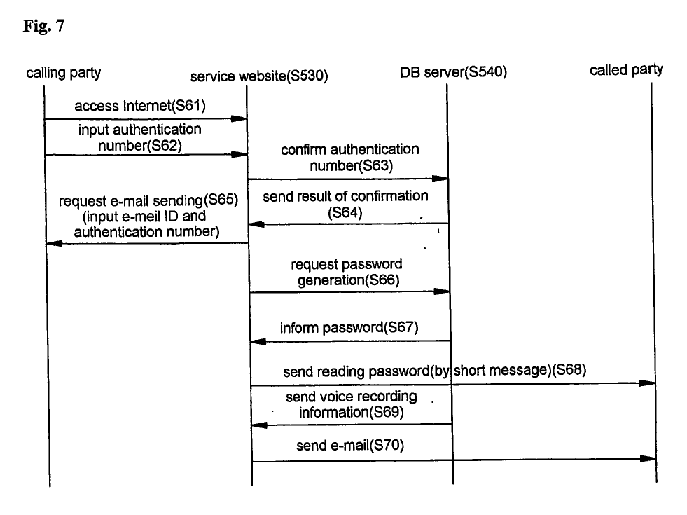

Herein as an embodiment of the additional procedure, if the ‘search path of voice recording information’ is to be sent through the e-mail of the Internet network 600, a safety device by means of which only relevant parties (the calling party and the called party) can confirm (or hear) the sent e-mail van be used as shown in FIG. 7.

FIG. 7 is a flow chart illustrating a process for transmitting a hearing path of the voice record information by means of the e-mail from the calling party to the called party via the Internet network so that the called party can hear the voice record information, in the telephone call recording proof service method according to the present invention.

When the calling party who knows the authentication number or the certificate number for the voice recording information recorded in the telephone call recording proof apparatus 500 wants to send the search path of the voice recording information recorded in the apparatus 500 to the called party via the e-mail, he accesses the service website 530 of the telephone call recording proof apparatus 500 via the Internet network 600 (Step S61) and inputs the authentication number to the service website 530 (Step S62). At this time, the telephone call recording proof apparatus 500 recognizes the authentication number inputted by the calling party as one recording number.

Next, the service website 530 having received the authentication number (recording number), requests the DB server 540 to confirm whether the inputted authentication number is present in the DB server 540 (Step S63).

Next, the DB server 540 informs the service website 530 of a result of the confirmation on whether the authentication number inputted by the calling party is present in the DB server 540 (Step S64).

Next, if the authentication number inputted by the calling party is not present in the DB server 540, the calling party is informed of the absence of the authentication number (this procedure is not shown in the figure).

Next, if it is confirmed in Step S64 that the authentication number is present, the calling party inputs an e-mail address of the called party and the authentication to the service website 530 in order to request the service website 530 to send the e-mail to the calling party (Step S65).

Next, the service website 530 requested by the calling party to send the e-mail requests the DB server 540 to generate a voice mail reading password (Step S66).

Next, the DB server 540 requested by the service website 530 to generate the password automatically generates the voice mail reading password and informs the service website 530 of the generated password (Step S67).

Next, the service website 530 sends the voice mail reading password, as a short message, by use of which the voice mail can be heard, to the called party having a called number recorded on the call recording of the voice recording information (Step S68). On the other hand, the voice mail reading password can be sent as one of a telephone voice message, the short message, and a telephone number Internet mail address identical to the called number. Accordingly, only a person receiving the voice mail reading password can hear the content of the voice call sent through the e-mail.

Next, the service website 530 sends the search path of the voice recording information (Step S69) from the DB server 540 to the called party via the e-mail (Step S70). The called party inputs the voice mail reading password separately received by him to the sent search path of the voice recording information and hears the voice recording information if the inputted password is equal to the password generated in the DB server 540 (this procedure is not shown in the figure).

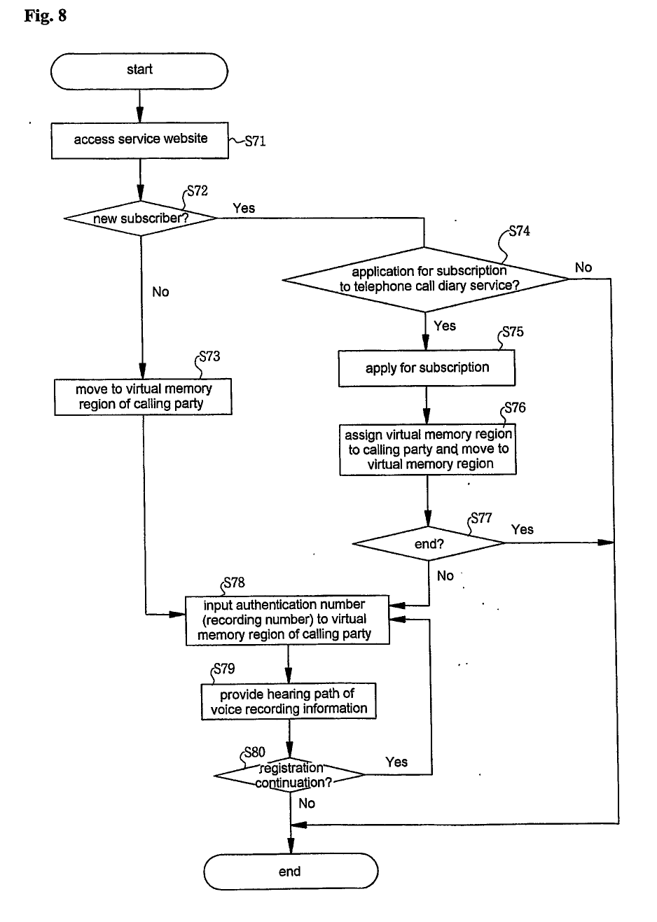

FIG. 8 is a flow chart illustrating a process where the calling party stores the content of the telephone call in a virtual memory region (a diary) assigned to him in the telephone call recording proof service method according to the present invention.

Initially, the service website 530 of the telephone call recording proof apparatus 500 assigns a virtual memory region (a diary) to the calling party and provides a telephone call diary service for preserving the telephone call content. The telephone call diary service preserves the telephone call content as one call record and provides the telephone call content to the calling party by a request from the calling party.

To this end, the calling party accesses the service website 530 of the telephone call recording proof apparatus 500 via the Internet network 600. (Step S71).

Next, the service website 530 determines whether the calling party, having accessed the service website 530, has subscribed to the telephone call diary service (Step S72). If the calling party has already subscribed to the telephone call diary service, then he moves to his virtual memory region (Step S73). If the calling party has not yet subscribed to the telephone call diary service, the service website 530 requests the calling party to subscribe to the telephone call diary service through Steps S74 to S77. After the calling party moves to his virtual memory region in Step S73, the calling party inputs the authentication number (recording number) to the virtual memory region (Step S78).

On the other hand, if it is determined in Step S72 that the calling party has not yet subscribed to the telephone call diary service, the service website 530 inquires of the calling party whether he wishes to subscribe to the telephone call diary service (Step S74). Then, if the calling party wants to subscribe to the telephone call diary service, he applies for subscription to the telephone call diary service according to predetermined procedures (Step S75), and otherwise, the access of the calling party to the service website 530 is terminated.

In Step S75, when the calling party applies for subscription to the telephone call diary service, the service website 530 requests the DB server 540 to assign a virtual memory region to the calling party. Then, the DB server 540 assigns the virtual memory region to the calling party and the calling party moves to his virtual memory region (Step S76).

Next, in Step S77, the service website 530 inquires of the calling party whether he wishes to terminate the access to the service website 530. If the calling party wants to terminate the access to the service website 530, the access to the service website 530 is terminated, and otherwise, the process proceeds to Step S78.

In Step S78, as mentioned earlier, after the calling party moves to his virtual memory region, he inputs his authentication number to the virtual memory region. At this time, the telephone call recording proof apparatus 500 recognizes the authentication number inputted by the calling party as one recording number.

Next, the service website 530 provides a path through which the calling party can hear the voice recording information to the calling party (Step S79).

Next, the service website 530 inquires of the calling party whether he wishes to continue to register the voice recording information in the virtual memory region (Step S80). If the calling party wants to do so, the process returns to Step S78, and otherwise, the access to the service website 530 is terminated.

Although the preferred embodiments of the present invention have been disclosed for illustrative purposes, those skilled in the, art will appreciate that various modifications, additions and substitutions are possible, without departing from the scope and spirit of the invention as disclosed in the accompanying claims.

1. A method of proving service for telephone call recording comprises the steps of:
the calling party telephoning a telephone call recording proof apparatus via a communication network and inputting a telephone number of a called party to the apparatus in order to apply for recording of telephone call content between the calling party and the called party;
the telephone call recording proof apparatus recording the telephone call content between the calling party and the called party, storing the recorded telephone call content as voice recording information, generating a unique authentication number for the stored voice recording information, and sending the generated unique authentication number to the calling party via the communication network;
the telephone call recording proof apparatus generating and storing call confirmation information by means of which the call between the calling party and the called party is confirmed;
the telephone call recording proof apparatus issuing a certificate for the recorded telephone call content when the calling party or a third party who knows the unique authentication number telephones the apparatus via the communication network and then inputs the unique authentication number to the telephone call recording proof apparatus; and
after the authentication process, the telephone call recording proof apparatus, allows the calling party or the third party to hear the recorded voice information via the communication network or sending the call confirmation information through which the telephone call can be confirmed to the calling party or the third party via the communication network.

2. The method as set forth in claim 1, wherein the step of issuing a certificate includes:
the calling party, telephoning the call recording proof apparatus via the communication network;
the calling party, inputting the unique authentication number to the telephone call recording proof apparatus;
the telephone call recording proof apparatus, confirming whether the authentication number put it by the calling party is present in the apparatus;
if the authentication number put in by the calling party is present in the telephone call recording proof apparatus, the telephone call recording proof apparatus, confirming whether the authentication number has been paid for;
if the authentication number has not yet been paid, the apparatus, requesting the calling party to pay for the authentication number and processing the payment of the calling party; and
the telephone call recording proof apparatus, issuing the certificate to the calling party via the communication network.

3. The method as set forth in claim 1, wherein the step of generating a unique authentication number for the stored voice recording information includes:
the telephone call recording proof apparatus confirming a telephone number of the calling party, informing the calling party that the telephone call is being recorded, and requesting the calling party to input the telephone number of the called party to the apparatus;
if the telephone number of the calling party is not confirmed, the apparatus sends the calling party a message informing that it is impossible to provide service to the calling party;
the calling party inputting the telephone number of the called party to the telephone call recording proof apparatus;
the telephone call recording proof apparatus telephoning the called party and establishing a call connection between the calling party and the called party;
the telephone call recording proof apparatus recording the telephone call content between the calling party and the called party;
the telephone call recording proof apparatus stopping the recording when the telephone call between the calling party and the called party is terminated;
the telephone call recording proof apparatus storing the recorded telephone call content between the calling party and the called party as voice recording information; and
the telephone call recording proof apparatus generating a unique authentication number for the voice recording information.

4. The method as set forth in claim 1, wherein the communication network includes wired and wireless communication networks, public switched telephone networks, internet communication networks, and satellite communication networks.

5. The method as set forth in claim 1, wherein the certificate includes a certificate number, the telephone number of the calling party, the telephone number of the called party, call date and call time, and details of issue of the certificate.

6. The method as set forth in claim 1, wherein the authentication number is one of the serial numbers specified in the telephone call recording proof apparatus, the telephone number of the calling party, and the telephone number of the called party, or a combination thereof.

7. A method of proving service for telephone call recording using a telephone call recording proof apparatus for recording telephone call content between a calling party and a called party as voice recording information by a request from the calling party and issuing an authentication number and a certificate for the recorded voice recording information to the calling party, the method comprising the steps of:
the calling party telephoning the telephone call recording proof apparatus and inputting a telephone number of the called party to the telephone call recording proof apparatus in order to record the telephone call content between the calling party and the called party;
the telephone call recording proof apparatus generating a unique authentication number for the recorded voice recording information and issuing the generated unique authentication number to the calling party via a communication network;
the calling party, telephoning the telephone call recording proof apparatus via the communication network and inputting the authentication number to the telephone call recording proof apparatus so that the calling party can hear the voice recording information;
the telephone call recording proof apparatus, receiving an e-mail address of the called party from the calling party after performing an authentication process for the authentication number;
the telephone call recording proof apparatus, generating a voice mail reading password by use of which the voice recording information can be heard and sending the generated voice mail reading password to the called party;
the telephone call recording proof apparatus, sending a search path of the voice recording information by use of which the voice recording information can be heard to the e-mail address of the called party;
the called party, accessing the search path of the voice recording information via an Internet network and inputting the voice mail reading password to the search path for performing an authentication process; and
after performing the authentication process, by the called party, hearing the voice recording information.

8. The method as set forth in claim 7, wherein the authentication number is one of the serial numbers received from the telephone call recording proof apparatus, the telephone number of the calling party, and the telephone number of the called party, or a combination thereof.

9. A method of proving service for telephone call recording using a telephone call recording proof apparatus for providing a telephone call diary service for recording and preserving telephone call content between a calling party and a called party, as voice recording information, in the form of a diary in a virtual memory region assigned to the calling party by a request from the calling party and issuing an authentication number and a certificate for the voice recording information recorded in the virtual memory region to the calling party, the method comprising the steps of:
the calling party telephoning the telephone call recording proof apparatus by inputting a called number of the telephone call recording proof apparatus and a telephone number of the called party sequentially to a telephone or a mobile terminal of the calling party in order to automatically record the telephone call content between the calling party and the called party;
the telephone call recording proof apparatus, generating an authentication number for the recorded voice recording information and issuing the generated authentication number to the calling party via a communication network;
the calling party, accessing the telephone call recording proof apparatus via Internet;
by the telephone call recording proof apparatus, determining whether the calling party is a subscriber to the telephone call diary service, and if the calling party is a subscriber, causing the calling party to move to the virtual memory region of the calling party, and otherwise, causing the calling party to move to a virtual memory region assigned after the calling party subscribes to the telephone call diary service through a subscription process;
the calling party, inputting the authentication number to the virtual memory region; and
the telephone call recording proof apparatus, providing a hearing path of the voice recording information to the calling party.

10. The method as set forth in claim 9, further comprises the steps of:
the calling party, inputting the authentication number to the telephone call recording proof apparatus; and
the telephone call recording proof apparatus, searching for the voice recording information corresponding to the inputted authentication number from the virtual memory region assigned to the calling party and providing the retrieved voice recording information to the calling party via the communication network.

11. The method as set forth in claim 9, further comprises the step of:
the calling party accessing the telephone call recording proof apparatus and hearing the recorded telephone call content after performing an authentication process using the authentication number.

12. The method as set forth in claim 9, wherein. the authentication number is one of the serial numbers received from the telephone call recording proof apparatus, the telephone number of the calling party, and the telephone number of the called party, or a combination thereof.

13. A system for proving service for telephone call recording, the system including a telephone call recording proof apparatus, wherein the telephone call recording proof apparatus records telephone call content between a calling party and a called party by a request from the calling party, generates a unique authentication number for voice recording information including the recorded telephone call content between the calling party and the called party, sends the generated unique authentication number to the calling party via a communication network, generates and stores call confirmation information by means of which the telephone call between the calling party and the called party is confirmed, and, after performing an authentication process for the authentication number inputted by the calling party or a third party via the communication network, sends the voice recording information to the calling party or the third party via the communication network so that the calling party or the third party can hear the voice recording information or sends the call confirmation information by use of which the telephone call can be confirmed to the calling party or the third party.

14. The system as set forth in claim 13, wherein the telephone call recording proof apparatus includes:
a call connection module for connecting with the calling party or the called party via the communication network;
a voice recording module for recording voice call after the voice recording module connects with the call connection module and storing the recorded voice call as voice recording information in a magnetic disk;
a service website for providing communication between the calling party and the called party via an Internet network; and
a database (DB) server including the magnetic disk in which the voice recording information is stored and instruction modules for executing database instructions for the voice recording information.

15. The system as set forth in claim 13, wherein the call confirmation information includes information on a telephone number of the calling party, a telephone number of the called party, call date and time, fact of call between the calling party and the called party, and the telephone call content.

16. The system as set forth in claim 13, wherein the telephone call recording proof apparatus records the telephone call content between the calling party and the called party in the form of a diary in a virtual memory region assigned to the calling party, and stores the recorded telephone call content as the voice recording information.

17. The method as set forth in claim 1, wherein the telephone call recording proof apparatus records the telephone call content between the calling party and the called party in the form of a diary in a virtual memory region assigned to the calling party, and stores the recorded telephone call content as the voice recording information.

18. The method as set forth in claim 1, wherein the step of sending the generated unique authentication number to the calling party includes:
if a call path of the calling party is not released, informing the calling party of the authentication number by voice, and if the calling party terminates the call, informing the calling party of the authentication number by voice or a short message by reestablishing a call connection with the calling party.

19. The method as set forth in claim 1, wherein the call confirmation information includes information on a telephone number of the calling party, a telephone number of the called party, call date and time, fact of call between the calling party and the called party, and the telephone call content.
